(19) United States
(12) Patent Application Publication
(10) Pub. No.: US 2017/0073782 A1
(43) Pub. Date: Mar. 16, 2017

(54) METHOD OF LOCAL HEAT TREATMENT FOR COLLISION PARTS OF VEHICLE USING HIGH FREQUENCY SIGNAL

(71) Applicant: Hyundai Motor Company, Seoul (KR)

(72) Inventor: Kyung-Bo Kim, Yongin (KR)

(21) Appl. No.: 14/949,596

(22) Filed: Nov. 23, 2015

(30) Foreign Application Priority Data
Sep. 15, 2015 (KR) 10-2015-0130401

(51) Int. Cl. C21D 1/42; H05B 6/06; C21D 1/26; H05B 6/10

(52) U.S. Cl. CPC C21D 1/42; H05B 6/101; H05B 6/06; C21D 1/26; C21D 2211/002; C21D 2211/008; C22C 38/04

(57) ABSTRACT

A method of locally softening collision components of a vehicle is provided. The method of includes generating a high frequency using a high-frequency generator, and extracting a final frequency and matched output using the high frequency through a control box including a capacitor and an inductor. The heat treatment portions of the component are locally softened by heating the heat treatment portions at temperature of about 400 to 550° C., by generating induced current using the final frequency and the matched output through a high-frequency coil.

### CROSS-REFERENCE TO RELATED APPLICATIONS

This application claims priority under 35 U.S.C. §119 to Korean Patent Application No. 10-2015-0130401, filed on Sep. 15, 2015, in the Korean Intellectual Property Office, the disclosure of which is incorporated herein by reference in its entirety.

### BACKGROUND OF THE INVENTION

1. Field of the Invention

The present invention relates to a method of locally softening collision components of a vehicle, and more particularly, to local heat treatment for collision components that enhances collision performance by preventing brittle breakage by achieving a desired tensile strength by locally applying high frequency heat treatment within a specific temperature range to heat treatment portions of components following formation a martensite structure through hot-stamping on boron steel.

2. Description of the Related Art

Generally, safety in collision and reduction of weight and cost are important design and development considerations for vehicles. Accordingly, safety devices including a safety belt and an airbag are used to reduce the degree of injury of passengers in a front end collision or a side collision of vehicles. However, passengers are usually injured by deformation of the vehicle body in collisions, so those safety devices are not the fundamental or complete solutions.

Recently, various attempts to reduce the deformation of a car body have been developed through the study of a vehicle formed from advanced high strength steel. As a result, ultra high strength components, having about 1500 MPa are manufactured using a high-temperature molding technology called hot-stamping. In the related art, hot-stamping is usually composed of blanking, heating, carrying, pressing, and quenching. In particular, a component is blanked into a desired size and the blank is heated at about 850° C. or greater that is an austenite transformation point (AC3). Thereafter, the heated blank undergoes press-forming and quenching by a carrying robot. In this case, heat from the blank is absorbed by a cooling water channel in a mold to allow for quenching. The material that has undergone pressing and quenching becomes a component having about 1500 MPa class ultra high strength and is used for the main collision components of vehicles.

As described above, a component that has undergone hot-stamping has the advantage of ultra high strength, but generally, the greater the strength of a material, the greater the extent of the brittle fractures. Accordingly, an ultra high strength components frequently exhibits substantial breakage when an external force is applied without plastic deformation. A local softening technology of the related art forms a mold structure divided into a cooling component (e.g., quenching, about 20° C.) and heating component (e.g., annealing, about 200 to 500° C.) by heating (e.g., about 800 to 1000° C.) a blank in a heating furnace to provide localized strength differences to a product. However, this engineering method makes it difficult to precisely control the local softened components due to a structural problem of a mold and there is a limit in applying the engineering method to a greater number of collision components.

The above information disclosed in this section is merely for enhancement of understanding of the background of the invention and therefore it may contain information that does not form the prior art that is already known in this country to a person of ordinary skill in the art.

### SUMMARY

The present invention provides a heat treatment method of preventing brittle brake by ensuring softness of a collision component by performing local softening within a specific temperature range, using high-frequency equipment on a stress concentration component s excessively deformed to prevent fracture of a component that has undergone hot-stamping.

In one aspect an exemplary embodiment of the present invention may include a method of local heat treatment using a high frequency to locally soften a component that has undergone hot-stamping. The method may include generating a high frequency using a high-frequency generator; extracting a final frequency and matched output using the high frequency through a control box that includes a capacitor and an inductor and locally softening heat treatment portions of the component by heating the heat treatment portions at temperature of about 400 to 550° C., by generating induced current using the final frequency and the matched output through a high-frequency coil.

According to an exemplary embodiment of the present invention, the component that has undergone hot-stamping may include carbon (C) of about 0.2 to 0.3 wt %, silicon (Si) of about 0.05 to 0.4 wt %, manganese (Mn) of about 1.0 to 1.7 wt %, and boron (B) of about 0.0008 to 0.005 wt %. The heating step may maintain the temperature for about 10 to 30 seconds until the structures of the heat treatment portions may be transformed into tempered martensite and bainite. The high frequency may have a frequency range of about 30 to 100 kHz.

The shape of the high-frequency coil may be adjusted to have a predetermined distance from the component that has undergone hot-stamping. The component that has undergone hot-stamping and the high-frequency heat treatment may be reduce in tensile strength by about 300 to 900 MPa, as compared with the tensile strength prior to the high-frequency heat treatment.

According to an exemplary embodiment of the method of high-frequency heat treatment for a collision component of the present invention, a local softening may be accomplished by heating a stress concentration portion that may be excessively deformed, within a specific temperature range using high-frequency equipment. Additionally, softness (e.g., flexibility or pliability) of a collision component may be provided and may prevent a brittle fracture of the component. The weight of the component may be reduced through optimization of design by providing different strengths to different portions of a component.

### BRIEF DESCRIPTION OF THE DRAWINGS

The above and other objects, features and other advantages of the present invention will be more clearly understood from the following detailed description when taken in conjunction with the accompanying drawings:

FIG. 1 is an exemplary view illustrating a collision component that has undergone hot-stamping according to an exemplary embodiment of the present invention;

FIG. 2 is an exemplary view illustrating heat treatment portions of the collision component according to an exemplary embodiment of the present invention;

FIG. 3 is an exemplary view illustrating a high-frequency coil according to an exemplary embodiment of the present invention;

FIG. 4 is an exemplary view illustrating a type of heat treatment on a collision component using a high-frequency coil accordingly to an exemplary embodiment of the present invention;

FIG. 5 is an exemplary view showing a microstructure before high-frequency heat treatment according to an exemplary embodiment of the present invention; and

FIG. 6 is an exemplary view showing a microstructure after high-frequency heat treatment according to an exemplary embodiment of the present invention.

### DETAILED DESCRIPTION

The present invention will be described more fully hereinafter with reference to the accompanying drawings, in which exemplary embodiments of the invention are shown. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

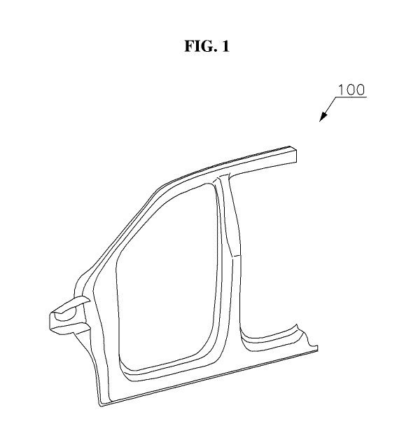

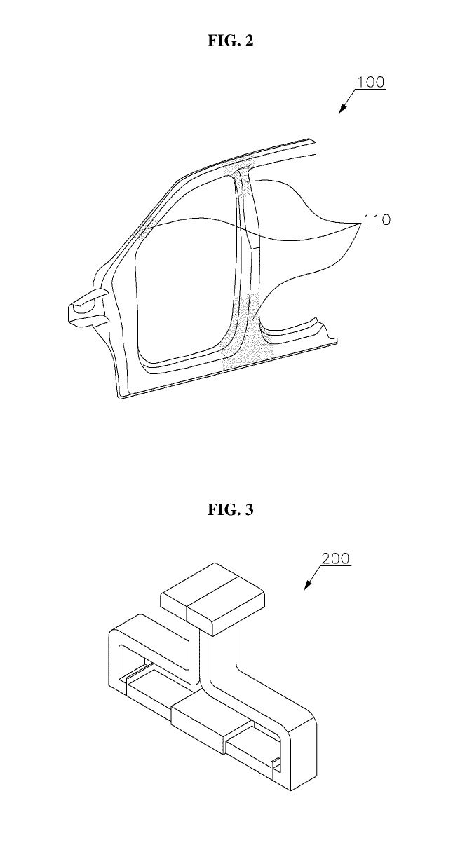

As shown, FIG. 1 illustrates an exemplary a collision component that has undergone hot-stamping and FIG. 2 illustrates an exemplary heat treatment portions of the collision component illustrated in FIG. 1. Referring to FIGS. 1 and 2, a side structure may be mounted on a side of a vehicle, in collision components for a vehicle, and a hot-stamped component 100 that high-frequency heat treatment may be applied to may be formed from an exclusive hot-stamping material called boron steel includes carbon (C) of about 0.2 to 0.3 wt %, silicon (Si) of about 0.05 to 0.4 wt %, manganese (Mn) of about 1.0 to 1.7 wt %, and boron (B) of about 0.0008 to 0.005 wt %.

The component 100 that has undergone hot-stamping may have the advantage of about 1500 MPa class ultra high strength, but generally, the higher the strength of a material, the greater the likelihood of the occurrence of a brittle fracture. Therefore an ultra high strength component may also break or fracture with minimal plastic deformation, when an external force is applied. Generally, a softening condition standard for performance of collision components is about 700 to 1000 MPa. Therefore, to prevent brittle fracture by locally reducing the tensile strength the positions that correspond to the heat treatment portions 110 of the collision component may be reduced to 700 to 1000 MPa

To achieve the desired tensile strength, a test measuring tensile strength based on a change in heating temperature and heating time was performed and the results are listed in Table 1 to Table 3.

TABLE 1

| | Heating | Heating | Tensile |
|---|---|---|---|
| | Temperature | Time | Strength |
| Item | (° C.) | (sec) | (MPa) |
| before heat treatment | — | — | 1500 |
| Embodiment 1 | 400 | 10 | 951 |
| Embodiment 2 | | 20 | 1001 |
| Embodiment 3 | | 30 | 1075 |
| Embodiment 4 | 450 | 10 | 887 |
| Embodiment 5 | | 20 | 973 |
| Embodiment 6 | | 30 | 1008 |
| Embodiment 7 | 500 | 10 | 730 |
| Embodiment 8 | | 20 | 788 |
| Embodiment 9 | | 30 | 876 |
| Embodiment 10 | 550 | 10 | 689 |
| Embodiment 11 | | 20 | 755 |
| Embodiment 12 | | 30 | 845 |

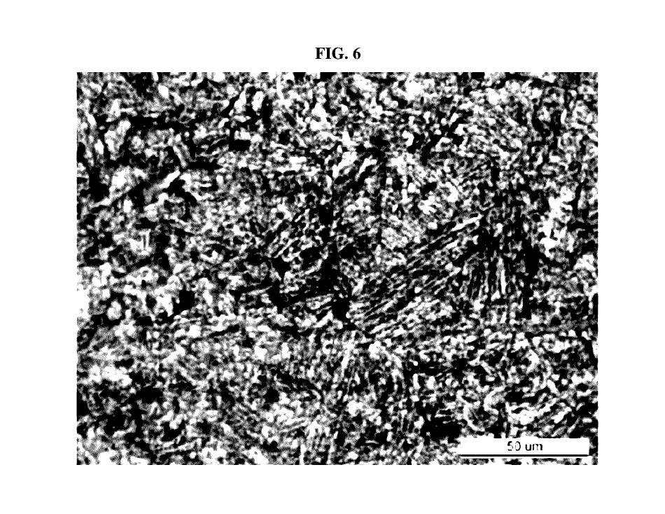

Table 1 lists changes in tensile strength after performing high-frequency heat treatment on the heat treatment portions 110 of the ultra high strength component that has undergone hot-stamping under conditions of heating temperature of 400 to 550° C. and maintaining time of 10 to 30 seconds that are ranges of the present invention. The tensile strength of the heat treatment portions 110 is 1500 Mpa, ultra-high strength before high-frequency heat treatment. However, the softness is insufficient (e.g., elongation percentage of about 4 to 10%), therefore a brittle fracture may be generated during a collision. For example, as shown in FIG. 5, the structure of the ultra high strength component 100 changes into a martensite structure through the hot-stamping. Accordingly, tempered martensite and bainite structures shown in FIG. 6 may be formed by performing local high-frequency heat treatment based on the order described below to ensure softness of about 700 to 1000 MPa which provides a tensile strength suitable for collision components.

In particular, a high frequency may be generated by a high-frequency generator. The frequency range may be about 30 to 100 kHz. A final frequency and matched output may be achieved from the high frequency by a control box that may include a capacitor and an inductor. Further, a high-frequency coil 200 may generate an induced current that uses the final frequency and the matched output and heats the heat treatment portions 110 of the component to about 400 to 550° C. The heating process may maintain the temperature for about 10 to 30 seconds until the structures of the heat treatment portions 110 are transformed into tempered martensite and bainite.

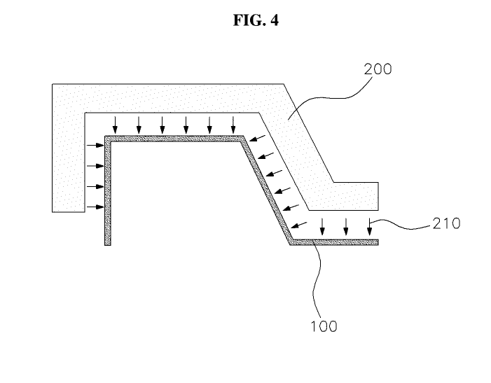

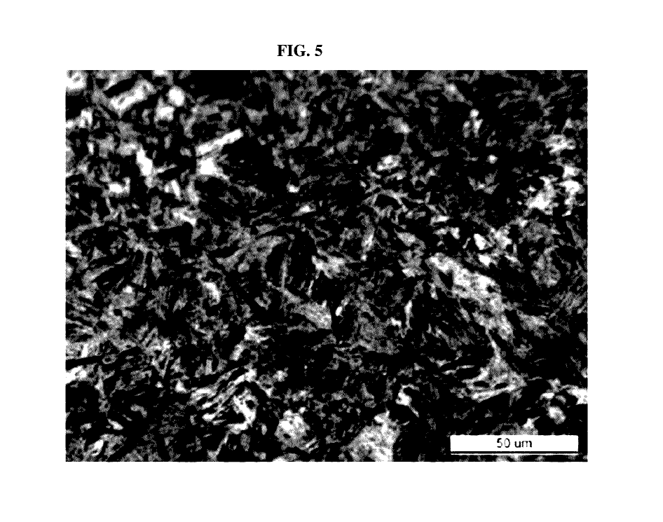

As illustrated in FIG. 4, the shape of the high-frequency coil 200 may be changed to have a predetermined distance from the component 100 that has undergone hot-stamping. Although the upper portion protrudes in an angled shape in the present invention, it may be formed in a curved shape, or may be recessed or flat.

As illustrated in FIGS. 5 and 6, the microstructures before and after high-frequency heat treatment illustrate that a martensite structure was formed prior to the heat treatment, but tempered martensite and bainite structures were formed after the heat treatment. The martensite structure, the hardest structure in the structure of steel, may be made of a steel forcibly including carbon. For example, when austenite is quenched, carbon may be discharged and there is insufficient time to transform from austenite to ferrite. However, the bainite structure, one of products formed by the cooling transformation of austenite, may include a structure formed within a middle temperature range between pearlite creation temperature and a martensite creation temperature. Further, the tempered martensite (troostite) may be a mixed structure of a iron and ultra-fine cementite, which may be made when martensite is tempered at about 400° C., and both of the structures have tensile strength in the range of about 700 to 1000 MPa.

Conversely, Table 2 and Table 3 list tensile strength measured when heating temperature exceeds the range of the present invention.

TABLE 2

| | Heating | Heating | Tensile |
|---|---|---|---|
| | Temperature | Time | Strength |
| Item | (° C.) | (sec) | (MPa) |
| Before Heat | — | — | 1500 MPa |
| Treatment | | | |
| Comparative | 300 | 10 | 1190 |
| Example 1 | | | |
| Comparative | | 20 | 1231 |
| Example 2 | | | |
| Comparative | | 30 | 1340 |
| Example 3 | | | |
| Comparative | 350 | 10 | 1034 |
| Example 4 | | | |
| Comparative | | 20 | 1150 |
| Example 5 | | | |
| Comparative | | 30 | 1190 |
| Example 6 | | | |

In the method of applying high-frequency heat treatment to the heat treatment portions 110 of the ultra high strength component that has undergone hot-stamping in Comparative Examples 1 to 6 in Table 2, the heat treatment maintaining time was 10 to 30 seconds. For example, the same time was used as in the present invention however the temperature range of about 400 to 550° C. of the present invention was used. In particular, changes were observed in tensile strength when the heating temperature is about 300° C. and 350° C., or in other words less than 400° C.

As described above, in general, a softening condition suitable for performance of collision components may be about 700 to 1000 MPa with respect to tensile strength. Further, the tensile strength was 1034 to 1231 MPa in Comparative Examples 1 to 6, thereby illustrating that achieving the desired tensile strength under a temperature condition less than 400° C. is not possible and 400° C. is the lower limit of the temperature range in the present invention.

TABLE 3

| | Heating | Maintaining | Tensile |
|---|---|---|---|
| | Temperature | Time | Strength |
| Item | (° C.) | (sec) | (MPa) |
| Before Heat | — | — | 1500 |
| Treatment | | | |
| Comparative | 600 | 10 | 601 |
| Example 7 | | | |
| Comparative | | 20 | 632 |
| Example 8 | | | |
| Comparative | | 30 | 701 |
| Example 9 | | | |

In an exemplary embodiment the method of applying high-frequency heat treatment to the heat treatment portions 110 of the ultra high strength component that has undergone hot-stamping is shown in Comparative Examples 7 to 9 in Table 3. The heat treatment maintaining time was about 10 to 30 seconds, the same as in the present invention. However, the temperature range of the present invention was about 400 to 550° C. and, changes in tensile strength occur when the heating temperature is about 600° C. or over 550° C.

In other words, the tensile strength may be about 601 to 701 MPa, out of the range of 700 to 1000 MPa and may provide a softening condition suitable for improved performance of collision components. Therefore, achieving a desired tensile strength under a temperature condition over 550° C. or in other words, the upper limit of the temperature range limited in the present invention may be unfeasible. Accordingly, to ensure about 700 to 1000 MPa or suitable tensile strength for collision components, the temperature range may be within about 400 to 550° C. and the heating time within about 10 to 30 seconds as the high-frequency heat treatment conditions, as shown in Embodiments 1 to 12 in Table 1.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A method of local heat treatment using a high frequency to locally soften a component that has undergone hot-stamping, comprising:
generating a high frequency using a high-frequency generator;
extracting a final frequency and matched output using the high frequency through a control box including a capacitor and an inductor; and
locally softening heat treatment portions of the component by heating the heat treatment portions at temperature of about 400 to 550° C., by generating induced current using the final frequency and the matched output through a high-frequency coil.

2. The method of claim 1, wherein the component that has undergone hot-stamping includes carbon (C) of about 0.2 to 0.3 wt %, silicon (Si) of about 0.05 to 0.4 wt %, manganese (Mn) of about 1.0 to 1.7 wt %, and boron (B) of about 0.0008 to 0.005 wt %.

3. The method of claim 1, wherein the heating maintains the temperature for about 10 to 30 seconds until the structures of the heated heat treatment portions transform into tempered martensite and bainite.

4. The method of claim 1, wherein the high frequency has a frequency range of about 30 to 100 kHz.

5. The method of claim 1, wherein the shape of the high-frequency coil is changed to have a predetermined distance from the component that has undergone hot-stamping.

6. The method of claim 1, wherein the component that has undergone hot-stamping and the high-frequency heat treatment reduces in tensile strength by about 300 to 900 MPa, as compared with before the high-frequency heat treatment.
